(19) United States
(12) Patent Application Publication
(10) Pub. No.: US 2015/0083663 A1
(43) Pub. Date: Mar. 26, 2015

(54) SYSTEM FOR ENHANCED RECLAIMED WATER RECOVERY

(71) Applicant: Pacific Advanced Civil Engineering, Inc., Fountain Valley, CA (US)

(72) Inventors: Andrew T. Komor, Irvine, CA (US); Keisuke Ikehata, Fountain Valley, CA (US)

(73) Assignee: Pacific Advanced Civil Engineering, Inc., Fountain Valley, CA (US)

(21) Appl. No.: 14/496,834

(22) Filed: Sep. 25, 2014

Related U.S. Application Data
(60) Provisional application No. 61/882,252, filed on Sep. 25, 2013.

(51) Int. Cl. C02F 1/44; B01D 61/08; C02F 1/463; B01D 21/00; C02F 1/40; C02F 1/465

(52) U.S. Cl. CPC C02F 1/442; C02F 1/40; C02F 1/465; C02F 1/463; B01D 21/0009; B01D 21/0084; B01D 61/08; C02F 2101/32
USPC 210/639; 210/195.2; 210/85; 210/650

(57) ABSTRACT

An apparatus for treating wastewater, such as high-solids contend wastewater from a fracking operation, includes a solids-oil-water separation apparatus coupled to a low-pressure membrane filtration apparatus, with a wastewater recycling conduit coupled at one end to the low-pressure membrane filtration apparatus and coupled at a second end to the solids-oil-water separation apparatus, whereby progressive recycling of membrane concentrate from the low-pressure membrane filtration apparatus through the wastewater recycling conduit, into the solids-oil-water separation apparatus, provides recovery of as much as 97% of the water from a raw wastewater stream.

### CROSS-REFERENCE TO RELATED APPLICATION

This application claims the benefit of U.S. provisional application No. 61/882,252, filed Sep. 25, 2013, the entire contents of which are incorporated herein by this reference.

### FIELD OF THE INVENTION

This invention is related to water purification and reclamation, in which contaminated water is treated by a series of unit processes, such as physical, chemical, and biological treatment processes, to recover reusable water.

### BACKGROUND OF THE INVENTION

Operation of certain processes generates wastewaters having high to very high levels of dissolved inorganic substances and salinity. These wastewaters are difficult to treat because of the very high salinity, which prohibits the use of conventional approaches such as reverse osmosis (RO) to remove undesirable constituents and recover reusable water. One example of such processes is hydraulic fracturing, which is also called hydrofracturing or fracking. Fracking is a technique utilized by oil and gas companies that uses high pressure water injected into the crust of the earth to break up hard-to-reach geological formations and release oil and natural gas for extraction. This process requires, on average, four to eight million gallons of water over the lifetime of a single well. However, as many of these fracking operations take place in dry and/or remote areas that do not have easy access to a large volume of water, fracking companies face resistance from other special interests, as the addition of a new water user is undesirable to the local community.

In fracking operations, there exist potential avenues for improving water usage. One of them is the reuse of spent fracking water (called flowback water) and produced water in next fracking operations on site or off site. This is a desirable possibility, but the water reuse poses some challenges. Several liquid wastes (i.e., wastewaters) are generated within the fracking operations, including flowback water during fracturing and produced water during gas/oil production. These wastewaters are generally unsuitable for re-injection for fracking as is because they contain high levels of constituents like dissolved ions, emulsified colloids, hydrocarbons, oil and grease, silt, and other suspended solids. Among the dissolved ions, scale-forming divalent cations, such as calcium (Ca²⁺), magnesium (Mg²⁺), barium (Ba²⁺), and strontium (Sr²⁺), as well as di- and trivalent iron (Fe²⁺ and Fe³⁺), found in the fracking wastewaters could be the primary reason for the inability to reuse them as is in fracking. These dissolved cations precipitate and deposit as carbonate, sulfate, oxide, and/or hydroxide salts and form thick layers of inorganic scales that may damage drilling and pumping equipment. Therefore, treatment is required to produce reclaimed water that is suitable for reuse on site or off site.

In general, wastewater treatment has many possible methodologies or processes available, and a series of processes can be used depending on the source water quality and desired finished water quality and quantity. Typically, the first group of processes is dedicated to suspended solids and oil removal, while a subsequent group of processes removes dissolved constituents, such as dissolved inorganic and organic compounds. Examples of the first group are settling basins, filters, and flotation devices, while the latter group includes aerobic and anaerobic biological treatment, chemical oxidation, high-pressure membrane processes, such as RO and disinfection. For brackish and saline wastewaters that contain high concentrations (>1,000 mg/L) of total dissolved solids (TDS), the use of a certain desalination process such as RO is usually required. In addition to RO, thermal processes such as multi-stage flash distillation and membrane distillation are often considered.

Currently, there are virtually no existing commercial-scale facilities that can effectively treat wastewaters having very high levels of TDS and salinity (>100,000 mg/L), such as fracking wastewaters, and turn them into reusable water. This is because the presence of very high levels of dissolved constituents makes the recovery of reclaimed water using conventional processes cost-prohibitive. In addition, generation of secondary liquid waste streams, such as brine or concentrate from conventional RO processes, is another drawback of conventional approaches.

### SUMMARY OF THE INVENTION

In one aspect of the present invention, the recovery of reclaimed water in a wastewater treatment facility is improved by recycling a portion of concentrate stream from a low-pressure membrane filtration apparatus, which is otherwise wasted, to an upstream solid-oil-water separation apparatus, such as an electrochemical reactor.

The aqueous medium to be treated contains a TDS level of greater than 10,000 mg/L. Such high TDS content wastewater may be found in, for example, but not limited to, oil and gas exploration, hydraulic fracturing, oil sands surface mining and in situ extraction, coal and mineral mining, agricultural drainage water, and wells and streams affected by seawater and other saline water sources.

The high TDS wastewater is first treated by a solid-oil-water separation apparatus such as one or more electrochemical reactor(s) where electrochemically generated low-solubility metal cations such as aluminum (Al³⁺) and ferrous iron (Fe²⁺) and their oxides and hydroxides aid the separation of suspended solids and oil droplets from water, which is further treated by a low pressure membrane filtration apparatus to remove majority of divalent cations and divalent anions and organic matter, as well as some of monovalent ions. A fraction of concentrate stream from the low-pressure membrane filtration apparatus is sent back to the electrochemical reactor(s) and the remainder of the concentrate stream is wasted. A low-pressure membrane filtration concentrate may contain high levels of divalent cations and anions along with monovalent cations and anions originally present in the aqueous medium to be treated. The divalent cations may be precipitated in the solid-oil-water separation apparatus by electrochemically generated or externally supplemented hydroxide ions (OH⁻) combined with carbonate/bicarbonate ions (CO₃²⁻/HCO₃⁻) already present or externally supplemented in a form of carbon dioxide in the aqueous medium. The recycling process reduces the rate of final waste generation and increases overall reclaimed water recovery, while maintaining the quality of reclaimed water, especially scale-forming di- and trivalent cations such as Ca²⁺, Mg²⁺, Ba²⁺, Sr²⁺, Fe²⁺, and Fe³⁺, as well as di- and trivalent anions such as sulfate (SO₄²⁻) and orthophosphate (PO₄³⁻).

The overall recovery of reclaimed water which is low in scale-forming ions may be as much as 85% without concentrate recycling to a solid-oil-water separation apparatus. The overall reclaimed water recovery with concentrate recycling may be as much as 97% by recycling as much as 82.5% of the low-pressure membrane filtration apparatus concentrate. This approach greatly reduces the volume of liquid waste stream to be disposed of, while maximize reusable reclaimed water recovery.

### BRIEF DESCRIPTION OF THE DRAWINGS

FIG. 1 illustrates the flow schematic of the wastewater treatment system without concentrate recycling. The recovery of reclaimed water may be as much as 85%.

FIG. 2 illustrates the proposed method of concentrate recycling for enhanced reclaimed water recovery. By sending as much as 82.5% of the concentrate from a low-pressure membrane filtration apparatus, the overall recovery of reclaimed water may be increased up to 97%.

FIG. 3 provides the experimental data of the removal of suspended and dissolved materials by the method described above.

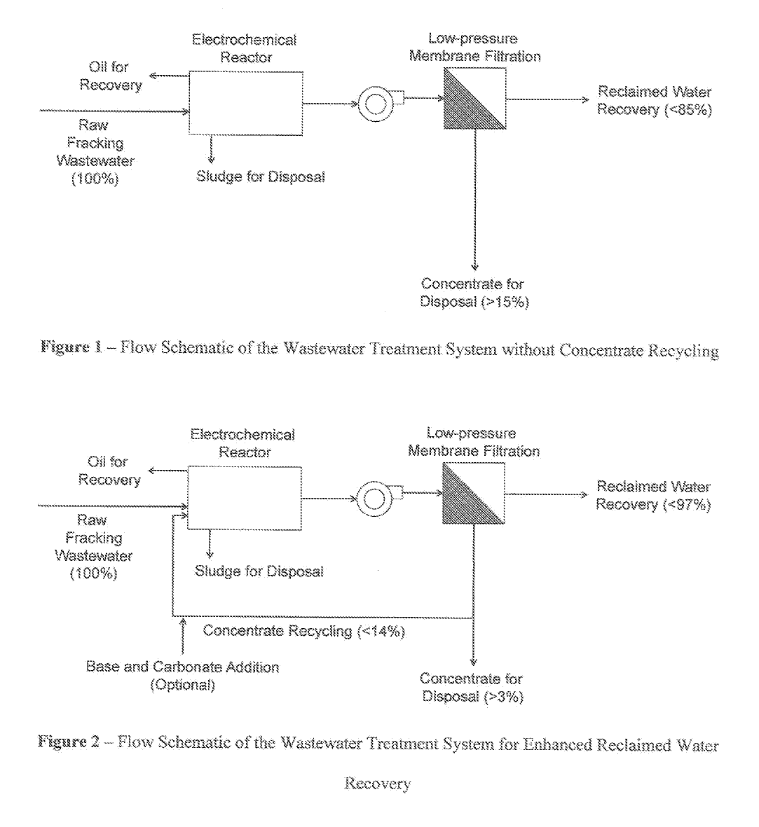

### DETAILED DESCRIPTION OF EXEMPLARY EMBODIMENTS

The wastewaters that can be treated by the proposed method can be characterized by very high TDS content and moderate to high hardness content. Table 1 presents the exemplary wastewater characteristics. FIG. 2 shows a flow schematic of the wastewater treatment system for enhanced reclaimed water recovery.

TABLE 1
Exemplary Wastewater Characteristics (Fracking Wastewaters)

| Parameter | Chemical Characteristics | Range |
|---|---|---|
| pH | Acidity/Basicity | 5-8 |
| Total dissolved solids (mg/L) | Salinity | 4,000-200,000 |
| Total suspended solids (mg/L) | Insoluble solids | 10-3,200 |
| Color at 455 nm (PtCo CU) | Organics, suspended | 2,000-10,000 |
| | solids | |
| Hardness (mg/L as CaCO₃) | Precipitation and scaling | 160-44,000 |
| Silica (mg/L as SiO₂) | Scaling | 0-70 |
| Alkalinity (mg/L as CaCO₃) | Precipitation and scaling | 270-800 |
| Chemical oxygen demand | Dispersed/emulsified oil, | 160-10,000 |
| (mg/L) | dissolved organics | |

The high TDS wastewater is first treated by a solid-oil-water separation apparatus such as an electrochemical reactor to remove suspended solids and oil droplets from water. Electrochemical reactors such as electrocoagulation and electroflotation units may be used individually, in series, or in parallel followed by a one or more gravity separation tanks that are equipped with bottom sludge and floating scum collection systems. Sacrificial anodes such as iron and aluminum that produce oxidized metal ions that precipitate as hydroxides and oxides along with cathodes of any conductive materials may be used in electrocoagulation. At the anode made of metal M, the following electrochemical reactions occur:

M₍ₛ₎→M_{(aq)}ⁿ⁺+ne⁻

2H₂O→4H⁺_{(aq)}+O_{2(g)}+4e⁻

In the presence of chloride ions (Cl⁻), the following reaction occurs at anode instead of oxygen gas [O_{2(g)}] generation;

2Cl⁻→Cl₂+2e⁻

At the cathode the following electrochemical reactions occur:

M_{(aq)}ⁿ⁺+ne⁻→M₍ₛ₎

2H₂O+2e⁻→H_{2(g)}+2OH⁻

In the electrochemical reactor(s), the metal cations (e.g., Al²⁺, F²⁺, and Fe³⁺) generated at the anode react with hydroxide ion generated at the cathode and form a mixture of water insoluble metal hydroxides and oxides [e.g., Al(OH)²⁺, Fe(OH)₃] flocs, which react with emulsified and colloidal matter (such as fine inorganic particles and oil droplets) to destabilize and coagulate/flocculate the suspended, emulsified, and colloidal matter. This process is called electrocoagulation. The lighter fraction of coagulated/flocculated matter (e.g., oil and hydrocarbons) tends to float, while the heavier fraction (e.g., silt particles) tends to settle down. In the electrochemical reactor, hydrogen, gas [H_{2(g)}] generated at the cathode forms bubbles that intrinsically aid the flotation of the lighter fraction. This process is called electroflotation. Both electrocoagulation and electroflotation processes may be achieved in one unit or separate electrocoagulation and electroflotation units may be used in series to facilitate the individual processes. In addition to coagulation-flocculation-flotation/sedimentation, many other side reactions, including oxidation of reduced substances by reactive chlorine species generated at the anode may also occur simultaneously.

The effluent from the solid-oil-water separation apparatus contains much less dissolved and suspended organic matter, including oil (40% to 100% removal), and suspended solids (up to 100% removal) as compared with untreated wastewater. Water loss (i.e., generation of aqueous waste stream) in the solid-oil-water separation apparatus is minimal.

The effluent from a solid-oil-water separation apparatus is further treated by a low-pressure membrane filtration apparatus, with or without intermediate treatment steps such as (but not limited to) sand filtration, microfiltration, and chemical and media addition. In the low-pressure membrane filtration apparatus, majority of di- and trivalent ions, including scale-forming cations and anions (e.g., Ca²⁺, Mg²⁺, Ba²⁺, Sr²⁺, Fe²⁺, Fe³⁺, SO₄²⁻, and PO₄³⁻) and residual organic matter are removed, while most of monovalent ions (e.g., Na⁺, K⁺, and Cl⁻) pass through. A nanofiltration membrane filtration system with proper sodium chloride (NaCl) and magnesium sulfate (MgSO₄) rejection rates may be used as a low-pressure membrane filtration apparatus with or without chemical additions, such as acid/base, antiscalants, antifoulant, and dispersants. In one embodiment, the filtration medium is a spiral-wound, nanoporous membrane having a wide spacer. One or more such membranes may be utilized, with wastewater flow directed through the membranes either in series or in parallel. As much as 85% of the original flow may be recovered as reusable reclaimed water with low scale-forming cations and anions by the low-pressure membrane filtration apparatus, while as little as 15% of the original flow may turn into concentrate, which is also called reject, containing higher levels of di- and trivalent ions and organics.

The concentrate from the low-pressure membrane filtration apparatus is recycled back to the solid-oil-water separation apparatus by controlling one or more mechanical valves that control output from the low-pressure membrane filtration apparatus. The additional scale-forming cations introduced may be precipitated in the electrochemical reactor by reacting with hydroxide ion either generated at the cathode or supplemented externally [e.g., Ca(OH)₂] and carbonate/bicarbonate present in the raw or supplemented externally [e.g., CO₂, Na₂CO₃]. This controls the levels of scale-forming cations in the effluent of the solid-oil-water separation apparatus, so that the impact of the concentrate recycling to the low-pressure membrane filtration apparatus is kept minimal.

In one embodiment, one or more sensors are located at various points in the system to allow real-time monitoring of physical and chemical, properties of the wastewater. Nonlimiting examples of such properties include flow rate, temperature, pH, salinity, turbidity, total dissolved solids, and oxygen content. Sensors can be located upstream of the electrochemical reactor(s), between the electrochemical reactor(s) and the low-pressure membrane filtration apparatus, and/or downstream of the low-pressure membrane filtration apparatus. The sensors and the mechanical valves can be coupled to a microprocessor, thereby allowing automated control over the output and direction of flow from the low-pressure membrane filtration apparatus. Thus, membrane concentrate can be recycled to the electrochemical reactor(s) - - - concentrate recycling - - - while the membrane permeate is collected as reclaimed water. The membrane concentrate may be recycled back through the solid-oil-water separation apparatus, with additional hydroxide ion being generated in or added to the electrochemical reactor(s) as necessary, as previously described. Depending on the raw wastewater quality and the performance of the treatment system apparatuses, up to 82.5% of the concentrate from the low-pressure membrane filtration apparatus may be recycled back to the solid-oil-water-separation apparatus. This constitutes an overall reclaimed water recovery of up to 97%.

### NON-LIMITING WORKING EXAMPLES

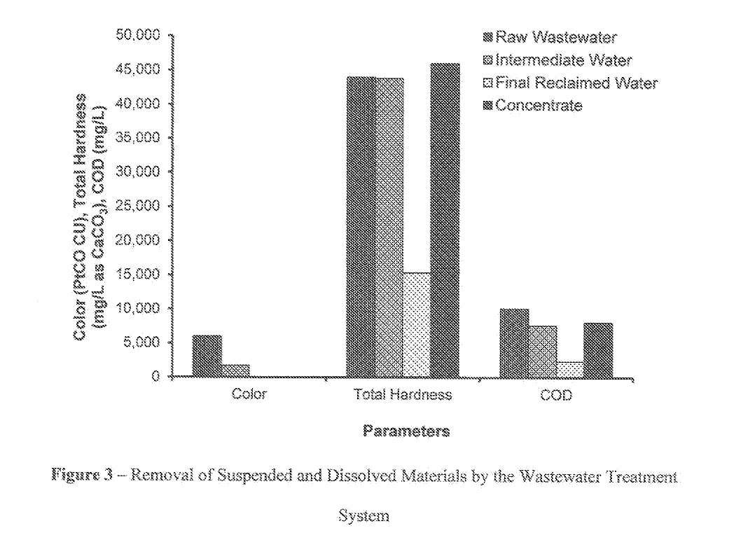

The following example illustrates one embodiment of the invention. The parameters of color, total hardness, and chemical oxygen demand (COD) are presented in FIG. 3.

A produced water sample obtained from a fracking operation in the Midwestern United States was treated by a semi-batch wastewater treatment system. The initial concentrations of TDS, total hardness, alkalinity, and COD were 293,000, 44,000, 360, and 10,100 mg/L, respectively, while initial values of pH and color (platinum-cobalt color scale (Pt—Co) color units) were 5.4 and 6,000, respectively. The experiment was conducted at temperature=24 to 26° C. FIG. 3 shows the removal, of suspended and dissolved materials by the method described above. The overall reclaimed water recovery was approximately 80% with concentrate recycling, whereas the recovery was 70% without recycling.

### REFERENCES

The following references are incorporated herein by reference as if set forth in their entirety:

Abdalla, C. W. et al. “Marcellus Education Fact Sheet: Water Withdrawals for Development of Marcellus Shale Gas in Pennsylvania,” Department of Agricultural Economics & Rural Sociology, College of Agricultural Science, Perm State University, 2010.

Colorado Division, of Water Resources “Water Sources and Demand for the Hydraulic Fracturing of Oil and Gas Wells in Colorado from 2010 through 2015,” Colorado Water Conservation Board, 2011.

Ground Water Protection Council, et al. “Modem Shale Gas Development in the United States: A Primer,” Work Performed for U.S. Department of Energy, Office of Fossil Energy and National Energy Technology Laboratory, 2009.

Haluszczak, L. O. et al. “Geochemical evaluation of flowback brine from Marcellus gas wells in Pennsylvania, USA.” Applied Geochemistry 2013, vol. 28, pp. 55-61.

Mollah, M. Y. A. et al. “Fundamentals, present and future perspectives of electrocoagulation” Journal of Hazardous Materials, 2004, vol. B114, pp. 199-210.

Valdiviezo Gonzales, L. G. et al. “Electroflotation of Magnetite Fines Using a Gram Positive Strain.” Proceedings of the XIII. International Mineral Processing Symposium, Oct. 10-12, 2012, Bodrum, Turkey, Paper #246.

Xiang, Y.-F. et al. “Treating oil wastewater with pulse electro-coagulation flotation technology.” Journal of Chongqing University, 2010, vol. 9.1, pp. 41-46.

What is claimed is:

1. An apparatus for treating wastewater, comprising:
a solids-oil-water separation apparatus;
a low-pressure membrane filtration apparatus, coupled to and downstream of the solids-oil water separation apparatus; and
a wastewater recycling conduit coupled at one end to the low-pressure membrane filtration apparatus and coupled at a second end to the solids-oil-water separation apparatus;
wherein the solids-oil-water separation apparatus has a raw wastewater inlet, an outlet for sludge, an outlet for partially treated water, and a recycle inlet coupled to the wastewater recycling conduit; and
wherein the low-pressure membrane filtration apparatus has a wastewater inlet coupled to the solids-oil-water separation apparatus outlet for partially treated water, a recycling outlet coupled to the wastewater recycling conduit, and a reclaimed water outlet.

2. The apparatus for treating wastewater recited in claim 1, wherein the solids-oil-water separation apparatus also has an inlet for adding a chemical base and/or carbonate.

3. The apparatus for treating wastewater recited in claim 1, wherein the solids-oil-water separation apparatus comprises one or more electrochemical reactors.

4. The apparatus for treating wastewater recited in claim 3, wherein the solids-oil-water separation apparatus comprises two or more electrochemical reactors connected to each other in series or in parallel.

5. The apparatus for treating wastewater recited in claim 3, wherein each of the one or more electrochemical reactors independently comprises an electrocoagulation unit or an electroflotation unit.

6. The apparatus for treating wastewater recited in claim 1, wherein the low-pressure membrane filtration apparatus comprises one or more nanoporous membranes.

7. The apparatus for treating wastewater-recited in claim 1, further comprising one or more valves for controlling output from the low-pressure membrane filtration apparatus.

8. The apparatus for treating wastewater recited in claim 7, wherein at least one of the one or more valves is operable to direct fluid flow from the low-pressure membrane filtration apparatus through the wastewater recycling conduit into the solids-oil-water separation apparatus.

9. The apparatus for treating wastewater recited in claim 1, further comprising one or more pumps coupled to at least one of the solids-oil-water separation apparatus, the low-pressure membrane filtration apparatus, and the wastewater recycling conduit.

10. The apparatus for treating wastewater recited in claim 1, further comprising one or more sensors for monitoring a wastewater physical or chemical property, located within and/or between the solids-oil-water separation apparatus, the low-pressure membrane filtration apparatus, and/or the wastewater recycling conduit.

11. The apparatus for treating wastewater recited in claim 1, further comprising one or more sand filters, microfilters, and/or ports for introducing a treatment chemical, located between the solids-oil-water separation apparatus and the low-pressure membrane filtration apparatus.

12. A method for treating wastewater, comprising: passing wastewater through the apparatus for treating wastewater recited in any one of claims 1-11.
